(19) United States
(12) Patent Application Publication
(10) Pub. No.: US 2006/0161612 A1
(43) Pub. Date: Jul. 20, 2006

(54) Method and structure for a generalized cache-register file interface with data restructuring methods for multiple cache levels and hardware pre-fetching

(75) Inventors: Fred Gehrung Gustavson, Briarcliff Manor, NY (US); John A. Gunnels, Brewster, NY (US); James C. Sexton, Yorktown Heights, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/035,902

(22) Filed: Jan. 14, 2005

(51) Int. Cl. G06F 7/38

(52) U.S. Cl. 708/495

(57) ABSTRACT

A method and structure for executing a matrix algorithm requiring an order of N³ operations including data reformatting operations, where N is a dimension of an operand of said algorithm on a computer, includes initially reformatting data for at least one matrix used in the matrix algorithm into a data structure stored in a memory, such that stride one data is presented for all submatrices used as operands involved in the matrix algorithm in a format required by the matrix algorithm with substantially no further data re-formatting beyond an order N data re-formatting required for executing the algorithm.

### CROSS-REFERENCE TO RELATED APPLICATIONS

The present Application is related to co-pending application, U.S. patent application Ser. No. 10/671,888, filed on Sep. 29, 2003, to Gustavson et al., entitled “METHOD AND STRUCTURE FOR PRODUCING HIGH PERFORMANCE LINEAR ALGEBRA ROUTINES USING REGISTER BLOCK DATA FORMAT ROUTINES”, having IBM Docket YOR920030169US1, assigned to the present assignee, and incorporated herein by reference.

### U.S. GOVERNMENT RIGHTS IN THE INVENTION

This invention was made with Government support under Contract No. B517552, awarded by the United States Department of Energy. The Government has certain rights in this invention.

### BACKGROUND OF THE INVENTION

1. Field of the Invention

The present invention generally relates to increasing efficiency in executing dense algebra algorithms that ordinarily require an order of N³ operations, including data reformatting operations. More specifically, by storing matrix data in memory in stride one format that is consistent with the data format used by kernels that execute the algorithm, the data reformatting normally required by these kernels is mostly eliminated, thereby reducing the number of execution steps from an order of N³ down to an order of N². Moreover, by choosing an appropriate format for the algorithm execution, including possibly a format in which operands are expressed in transpose format, the entire matrix algorithm, including these kernel subroutines, can be written in a high level language, eliminating the constraint of having to use a low level language in order to optimize kernel subroutines.

2. Description of the Related Art

Modern processors offer both hardware and software prefetching in order to reduce cycle time for getting data into the floating point registers. The present invention is concerned with algorithms for dense linear algebra. The key algorithm in this regard is matrix multiply.

Of course, there are others. Examples are the Level 3 BLAS (Basic Linear Algebra Subprograms) consisting of nine complex and six real routines. It is noted that complex and real matrix multiply are included in the L3 BLAS. Other examples are the factorization parts of DLAFA (Dense Linear Algebra Factorization Algorithms). The above terminology, as well as other terminology related to linear algebra subroutines, will be explained in more detail shortly.

In these examples, all routines consist of a blocking algorithm which repeatedly calls kernel routines. A key kernel is the DGEMM (Double-precision GEneralized Matrix Multiply) kernel. The other kernels are all “DGEMM like”. This means that the majority of the operations in other kernels are identical to the operations done by the DGEMM kernel. Therefore, for purpose of the following discussion, it suffices to concentrate on the DGEMM kernel.

Scientific computing relies heavily on the matrix processing methods of linear algebra. In fact, the whole field of engineering and scientific computing takes advantage of linear algebra for computations. Linear algebra routines are also used in games and graphics rendering. Typically, these linear algebra routines reside in a math library of a computer system that utilizes one or more linear algebra routines as a part of its processing. Linear algebra is also heavily used in analytic methods that include applications such as a supply chain management.

Linear Algebra Subroutines

The explanation of the present invention includes reference to the computing standard called LAPACK (Linear Algebra PACKage) and to various subroutines contained therein. Information on LAPACK is readily available on the Internet.

ScaLAPACK is LAPACK as adapted for use on parallel-processor computer architectures. Both ScaLAPACK and LAPACK are based on Basic Linear Algebra Subprograms (BLAS).

For purpose of discussion only, Level 3 BLAS of the LAPACK (Linear Algebra PACKage) are used, but it is intended as being understood that the concepts discussed herein are easily extended to other linear algebra mathematical standards and math library modules.

When LAPACK is executed, the Basic Linear Algebra Subprograms (BLAS), unique for each computer architecture and provided by the computer vendor, are invoked. LAPACK comprises a number of factorization algorithms for linear algebra processing.

For example, Dense Linear Algebra Factorization Algorithms (DLAFAs) include matrix multiply subroutine calls, such as Double-precision GEneralized Matrix Multiply (DGEMM). At the core of Level 3 Basic Linear Algebra Subprograms (BLAS) are “L1 kernel” routines which are constructed to operate at near the peak rate of the machine when all data operands are streamed through or reside in the L1 cache.

It is noted that the terminology “Level 2” and “Level 3” refers to the looping structure of the algorithms. Level 1 BLAS routines use only vector operands and have complexity O(N), where N is the length of the vector and, hence, the amount of data and operations involved is O(N). Level 2 BLAS routines are matrix-vector functions and involve O(Nˆ2) computations on O(Nˆ2) data. Level-3 BLAS routines involve multiple matrices and involve O(Nˆ3) computations on O(Nˆ2) data. The present invention particularly addresses the O(Nˆ3) DLAFA computations that traditionally invoke the Level-3 BLAS routines multiple times.

The most heavily used type of level 3 L1 DGEMM kernel is Double-precision A Transpose multiplied by B (DATB), that is, C=C−A^{T}*B, where A, B, and C are generic matrices or submatrices, and the terminology A^{T} means the transpose of matrix A.

The DATB kernel operates so as to keep the A operand matrix or submatrix resident in the L1 cache. Since A is transposed in this kernel, its dimensions are K1 by M1, where K1×M1 is roughly equal to the size of the L1. Matrix A can be viewed as being stored by row, since in Fortran, a non-transposed matrix is stored in column-major order and a transposed matrix is equivalent to a matrix stored in row-major order. Because of asymmetry (C is both read and written) K1 is usually made to be greater than M1, as this choice leads to superior performance.

A number of methods have been used to improve performance from new or existing computer architectures for linear algebra routines. However, because linear algebra permeates so many calculations and applications, a need continues to exist to optimize performance of matrix processing in any way possible.

Relative to the technique of the present invention, as recognized by the present inventors, overall performance loss can occur for linear algebra processing at the L1 cache-to-FPU interface because of data reformatting required as blocks of matrix data are transferred into the FPU register file from memory, typically consisting of one or more levels of cache memory. As will be explained below, the conventional methods of linear algebra subroutine execution consume an order of N³ data reformatting operations as a routine processing requirement to execute the linear algebra kernel, where N is presumed to be the dimension of the matrix.

The present invention, therefore, addresses the problem of increasing efficiency of linear algebra operations by recognizing the problem that conventional methods cause more data reformatting operations than necessary, thereby causing overall inefficiency in matrix processing algorithms.

### SUMMARY OF THE INVENTION

In view of the foregoing, and other, exemplary problems, drawbacks, and disadvantages of the conventional systems, it is an exemplary feature of the present invention to provide a structure (and method) in which matrix processing is optimized, for example, at the interface of the L1 cache and the FPU.

It is another exemplary feature of the present invention to provide a method in which matrix data is reformatted a single time, as a preliminary step to a matrix operation in an FPU, in conformity with the most efficient data structure for the lower level kernel subroutine that will execute the matrix operation.

It is another exemplary feature of the present invention to provide a method in which the number of data reformatting operations is reduced from O(N³) down to O(N²) for matrix processing.

It is yet another exemplary feature of the present invention to provide a method in which matrix subroutines can be written entirely in a high level language, such as C or Fortran, using a standard compiler, and still achieve the benefits in efficiency of programs optimized by writing code at the assembly language level.

It is still another exemplary feature of the present invention to recognize that one source for lack of efficiency in writing matrix subroutines in higher level languages is that these languages provide matrix storage in either columns OR rows, but fail to provide the capability to store matrix data in columns AND rows that would be most efficient for the lower level matrix processing subroutines.

It is another exemplary feature of the present invention to provide a method that, in recognition that the linear algebra kernel has a determinable most efficient data structure format, to provide the most efficient matrix data structure, thereby allowing data reformatting to be reduced for matrix processing from O(N³) down to O(N²).

It is another exemplary feature of the present invention to teach that linear algebra subroutines may have to be written in a transpose format, such that the operation is executed in the equivalent format in which one or more matrices is processed after having been expressed as the transpose of that matrix.

To realize the above features, in a first exemplary aspect of the present invention, described herein is a method of executing a matrix operation on a computer, including initially reformatting data for at least one matrix used in the matrix operation into a data structure stored in a memory, such that stride one data is presented for all submatrices involved in the matrix operation in a format required by the matrix operation with substantially no further data re-formatting beyond an order N² data re-formatting required for executing the operation, where N is a dimension of the operands.

In a second exemplary aspect of the present invention, described herein is an apparatus including a data formatting module to place matrix data into a data structure prior to processing the data in a linear algebra operation, the data structure providing a data format for the processing that requires substantially no additional data re-formatting beyond an order N² data re-formatting required for executing the operation, where N is a dimension of the operands.

In a third exemplary aspect of the present invention, also described herein is a signal-bearing medium tangibly embodying a program of machine-readable instructions executable by a digital processing apparatus to perform a linear algebra operation, including a data formatting module to place matrix data into a data structure prior to processing the data in a linear algebra operation, the data structure providing a data format for the processing that requires substantially no additional data formatting beyond an order N² data re-formatting required for executing the operation, where N is a dimension of the operands.

### BRIEF DESCRIPTION OF THE DRAWINGS

The foregoing and other purposes, aspects and advantages will be better understood from the following detailed description of an exemplary embodiment of the invention with reference to the drawings, in which:

FIG. 1 illustrates an exemplary linear algebra operation 100;

FIG. 2 illustrates an exemplary hardware/information handling system 200 upon which the present invention can be implemented;

FIG. 3 exemplarily illustrates a CPU 211 that includes a floating point unit (FPU) 302;

FIG. 4 exemplarily illustrates in more detail a CPU 211 that might be used in the computer system 200 of FIG. 2;

FIG. 5 illustrates in flowchart format 500 an exemplary embodiment of the present invention;

FIG. 6 illustrates the concept 600 of vector formatting in stride one that can be used to execute the present invention;

FIG. 7 illustrates in software block diagram format 700 an exemplary embodiment of the present invention; and

FIG. 8 illustrates a signal bearing medium 800 (e.g., storage medium) for storing steps of a program of a method according to the present invention.

### DETAILED DESCRIPTION OF AN EXEMPLARY EMBODIMENT OF THE INVENTION

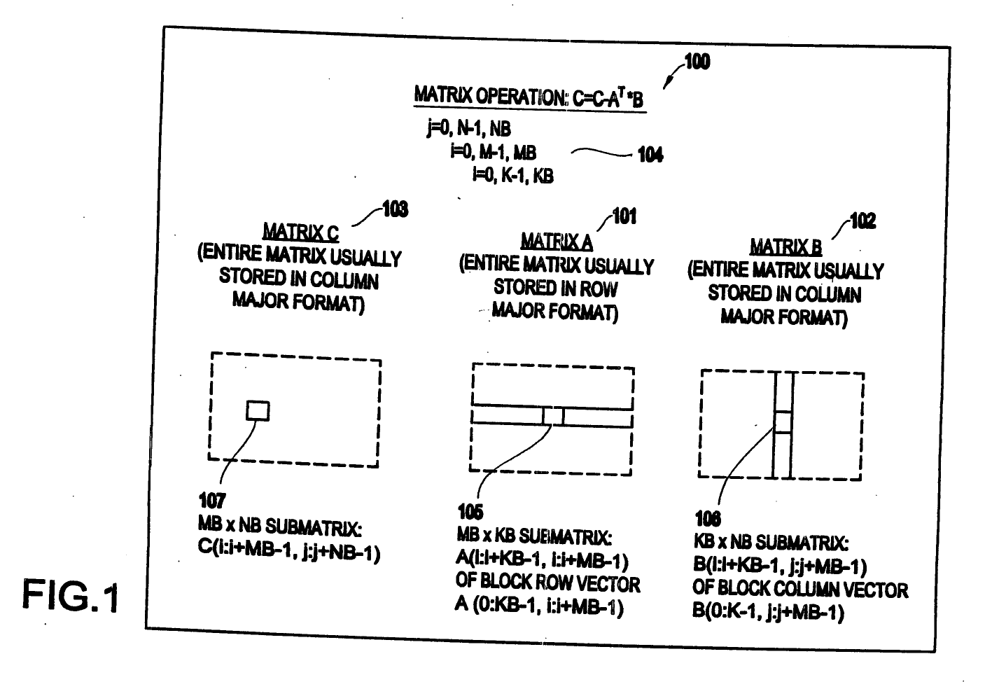

Referring now to the drawings, and more particularly to FIGS. 1-8, an exemplary embodiment of the method and structures according to the present invention is now described.

The present invention addresses, generally, efficiency in the calculations of linear algebra routines by focusing on the data transfer at the L1:FPU interface. More specifically, presuming a matrix of dimension N×N, by reformatting data one time as described shortly, reformatting operations can be reduced in number from the order of N³ required by conventional methods down to the order of N² (e.g., from O(N³) down to O(N²)), thereby increasing the efficiency at this interface.

Although the present invention was developed in view of the Assignee's Blue Gene/L™ parallel computer, its benefits and applicability are not at all confined to this new computer architecture.

The above-referenced co-pending Application taught the use of a pseudo-matrix as one method to provide efficiency at the L1-to-FPU interface. The present invention teaches another method by which L1 matrix data can be transferred into FPU registers in an optimal manner.

In the context of the present invention, “prefetching” means the retrieval of the C, A^{T}, B submatrix blocks to L1 ahead of time. The term “preloading” refers to the technique of transferring the C, A^{T}, B submatrix blocks to the FPU registers in a timely manner for the FPU executions and subsequent transfer of the FPU results back to the L1 cache, higher order caches, or the memory.

FIG. 1 illustrates processing of an exemplary matrix operation 100 (e.g., C=C−A^{T}*B). In processing this operation, matrix A is first transposed to form transpose-matrix-A (e.g., A^{T}) 101.

Next, transposed matrix A^{T} is multiplied with matrix B 102 and then subtracted from matrix C 103. The computer program executing this matrix operation will achieve this operation using three loops 104 in which the element indices of the three matrices A, B, C will be varied in accordance with the desired operations of FIG. 1.

That is, as shown in the lower section of FIG. 1, the inner loop and one step of the middle loop will cause indices to vary so that MB rows 105 of matrix A^{T} will multiply with NB columns 106 of matrix B. The index of the outer loop will cause the result of the register block row/column multiplications to then be subtracted from the MB-by-NB submatrix 107 of C to form the new submatrix 107 of C. FIG. 1 shows an exemplary “snapshot” during execution of one step of the middle loop i=i:i+MB-1 and all steps of the inner loop 1, with the outer loop block variable fixed at j=j:j+NB-1.

The above matrix operation C=C−A^{T}*B is now examined in more depth. At any point the operation is: C(i:i+MB-1, j:j+NB-1)=C(i:i+MB-1, j:j+NB-1)−A(l:l+KB-i, i:i+MB-1)*B(l:l+KB-i, j:j+MB-1). Using standard column major format for C, A^{T}, and B would mean that the elements in submatrices C(i:i+MB-1, j:j+NB-1), A^{T}(l:l+KB-1, i:i+MB-1) and B(l:l+KB -1, j:j+NB-1) are not stored contiguously in some order that is advantageous for the FPU register file-L1 cache interface or the ability to stream data from higher level caches and memory to the L1 cache.

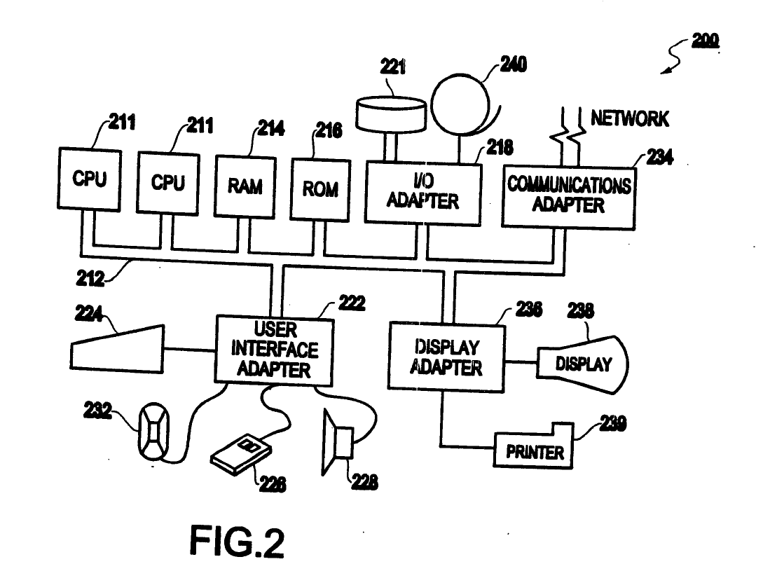

FIG. 2 shows a typical, generic hardware configuration of an information handling/computer system 200 upon which the present invention might be used. Computer system 200 preferably includes at least one processor or central processing unit (CPU) 211. Any number of variations are possible for computer system 200, including various parallel processing architectures and architectures that incorporate one or more FPUs (floating-point units) and their associated register files.

In the exemplary architecture of FIG. 2, the CPUs 211 are interconnected via a system bus 212 to a random access memory (RAM) 214, read-only memory (ROM) 216, input/output (I/O) adapter 218 (for connecting peripheral devices such as disk units 221 and tape drives 240 to the bus 212), user interface adapter 222 (for connecting a keyboard 224, mouse 226, speaker 228, microphone 232, and/or other user interface device to the bus 212), a communication adapter 234 for connecting an information handling system to a data processing network, the Internet, an Intranet, a personal area network (PAN), etc., and a display adapter 236 for connecting the bus 212 to a display device 238 and/or printer 239 (e.g., a digital printer or the like).

Although not specifically shown in FIG. 2, the CPU of the exemplary computer system could typically also include one or more floating-point units (FPUs) and their associated register files that perform floating-point calculations. Hereafter, “FPU” will mean both the units and their register files. Computers equipped with an FPU perform certain types of applications much faster than computers that lack one. For example, graphics applications are much faster with an FPU. An FPU might be a part of a CPU or might be located on a separate chip. Typical operations are floating point arithmetic, such as fused multiply/add (FMA), which are used as a single entity to perform floating point addition, subtraction, multiplication, division, square roots, etc.

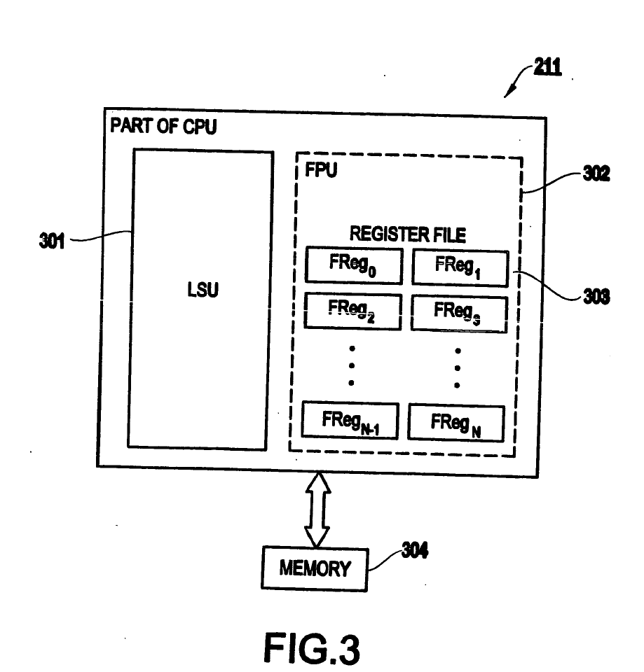

Details of the arithmetic part of the FPU is not so important for an understanding of the present invention, since a number of configurations are well known in the art. FIG. 3 shows an exemplary typical CPU 211 that includes at least one FPU 302. The FPU function of CPU 211 controls the FMAs (floating-point multiply/add), and at least one load/store unit (LSU) 301, which loads/stores data to/from memory device 304 into the floating point registers (FReg's) 303).

It is noted that, in the pretext of the present invention involving linear algebra processing, the term “FMA” can also be translated either as “fused multiply-add” operation/unit or as “floating-point multiply followed by floating point add” operation/unit, or a single floating point multiply or a single floating point add or subtract. It is not important for the present discussion which translation is used. The role of the LSU 301 is to move data from a memory device 304 external to the CPU 211 to the FRegs 303 and to subsequently transfer the results of the FMAs back into memory device 304, typically via the L1 cache (not illustrated in FIG. 3). It is important to recognize that the LSU function of loading/storing data into and out of the FRegs 303 occurs in parallel with the FMA function.

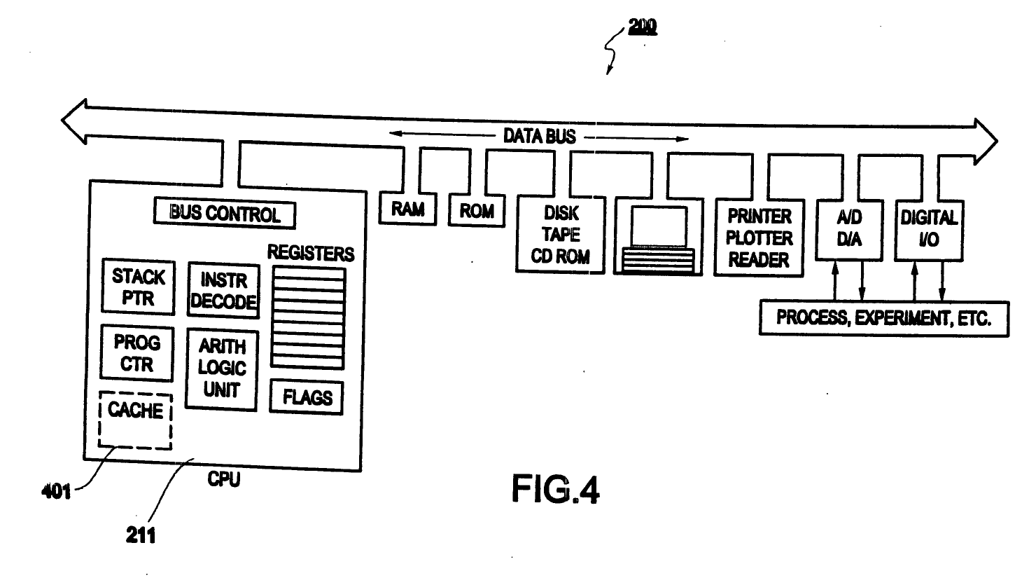

Another important aspect of the present invention relates to computer architecture that incorporates a memory hierarchy involving one or more cache memories. FIG. 4 shows in more detail how the computer system 200 might incorporate a cache 401 in the CPU 211.

Discussion of the present invention includes reference to levels of cache, and more specifically, level 1 cache (L1 cache). Level 1 cache is typically considered as being a cache that is closest to the CPU and might even be included as a component of the CPU, as shown in FIG. 4.

The details of the cache structure and the precise location of the cache levels are not so important to the present invention so much as recognizing that memory is hierarchical in nature in modern computer architectures and that matrix computation can be enhanced considerably by modifying the storage representation of a matrix that is the data of matrix subroutines to include considerations of the memory hierarchy.

Additionally, in the present invention, it is preferable that the matrix data be laid out contiguously in memory in “stride one” form. “Stride one” means that the data is preferably contiguously arranged in memory to honor double-word boundaries and that the useable data is retrieved in increments of the line size. This contiguous arrangement of data facilitates bringing the data from higher levels of memory or higher levels of cache into L1 cache.

A small register block, representing a submatrix of C of about the size of the FPU register file is updated by multiplying together submatrices of A and B by the FPU, in accordance with the example in FIG. 1 and the discussion above. Assuming the use of column-major storage, the block sizes are mb, nb, kb, and mb+2*nb or 2*mb+nb streams of data from A, B, and C are required. Additionally, the importance of the L1 cache/FPU register file interface and its relation to HW/SW streaming was enunciated above (e.g., reference FIG. 1 and the discussion related thereto).

It will be shown that the standard arrays of Fortran and C, if properly interpreted, can be used to automatically enable HW/SW streaming. This invention shows how the streams can be reduced to a minimum of three.

Dense Linear Algebra (DLA) algorithms are usually expressed in Fortran or C. To better take advantage of HW/SW prefetching, stride-one access of the matrices used by DLA algorithms should be implemented.

Further, because O(N³) FPU operations are done on O(N²) data, it is practical to rearrange the storage format of the matrices. However, the standard linear algebra codes (such as LAPACK DLAFA) have re-arrangement costs that are O(N³).

In the discussion below, it will be shown how this data rearrangement can be done in a highly efficient manner. There are two key components:

(1) describes data mappings between Fortran and C two-dimensional (2D) arrays to stride one data layout; and

(2) describes a minimal amount of data rearrangement which is O(N²) as opposed to the known way of using O(N³) data rearrangement. A proof sketch of this second component will be provided in the following discussion For sake of discussion, it is assumed that A, B, C are conformable matrices for DGEMM. This means the common dimension k of A and B must be equal.

As any representation of a matrix X is also a representation of X′ (where the terminology “′” denotes transpose), it is concluded that DGEMM must resolve eight=2³ representations of its operands. (DGEMM only allows four operand representations; the other four are admitted via a transpose identity) This invention proposes the principle that a single data format is sufficient for DGEMM.

A given architecture and its DGEMM implementation team is expected to choose an internal format data for DGEMM. The data format proposed herein may turn out to be that format. In any case, it is demonstrated herein that a single format, instead of the four (eight) that the current DGEMM format allows, is indeed possible. Moreover, its salient features are that it enables the majority, if not all, of the high performance features of today's architectures.

DGEMM (C=C±op(A)*op(B), where op=“transpose” or “normal”, where “normal” means “do nothing”), accepts two data formats for A and B. These are column-/row-major formats for A, A′ and B, B′. Here “′” denotes transpose, “N” denotes normal (non-transposed), and “T” denotes transpose “′”. Also, it is noted that row major format for matrix X is identical to column major format for matrix X′. There are four possible data formats for (A, B), namely, (A, B)=(N, N), (T, N), (N, T) and (T, T).

In Fortran, DGEMM requires that the m by n input matrix C always be in column major format. Suppose that C is transposed to produce an n by m matrix, D, such that D=C′. It is noted that ldc≧m and ldd≧n (ldx=leading dimension of matrix X) is required for this data format. The information in C and D is the same.

Another way to say this is that a representation of C is also a representation of D (=C′) and vice versa. Now, since D is a valid Fortran array, DGEMM calculations can be performed on D. Let A and B be matrices associated with valid DGEMM calls on matrix C. Further, let E=A′ and F=B′.

Considering now only A. If A has format N, then E has format T and if A has format T, then E has format N. Again, the information in A and E is the same or, equivalently, A is both a representation of itself and of E=A′. The same thing is true for B, namely, B is both a representation of itself and of F=B′.

Returning now to DGEMM's four formats, and knowing that A(E) and B(F) contain the same information, the above discussion shows that the four format choices can be viewed as a single choice. This is important for several reasons.

These reasons emerge when one considers performance. The performance of DGEMM depends on the data format of its input operands.

Finally, there are four data formats for DGEMM with input operand D (taking the place of C) and the same matrices A, B (which may be viewed as E and F). For D, A and B take on the data formats: (T, T), (T, N), (N, T), and (N, N).

Here it is important to note that, in the DGEMM call, the roles of A and B are interchanged. This is because the transpose identities C=C−A*B iff D=D−F*E (there are three more cases). It is noted that, by substitution, D=D−F*E is C′=C′−B′*A′. So, there are really eight cases, four for C and four for D. Also, C(D), A(E), B(F) are representations of themselves and, taken as a whole, there are eight choices.

Given conformable matrices A, B, and C, and that DGEMM is to be performed, it is noted that DGEMM does 2*m*n*k flops and matrices A, B, C hold m*k+k*n+m*n elements, it is probably good, for efficiency, to choose an appropriate representation of A, B and C (that is, to re-format the data).

But DGEMM implementations change the data formats of input operands for performance purposes, so the above strategy may be counter productive.

The purpose of this explanation is to emphasize the level three nature of DGEMM (an order of magnitude more calculation than data access leads to the viability of data reformatting) and to indicate that DGEMM implementers choose their own formats for DGEMM's input data operands with the view of maximizing DGEMM's performance.

A matrix A of order N is now considered and it is supposed that a factorization of A is to be performed. Current math libraries usually factorize A by calling DGEMM and other BLAS multiple times on submatrices of A. The outer loop is over the columns J of A (DO J=1, N, NB) and here the repetition factor is n1=ceil (N/NB). That is, the outer loop index J assumes n1=ceil (N/NB) different values, where “ceil” denotes “rounding up” to the next integer value.

If DGEMM and other level 3 BLAS are choosing a different internal data format on every invocation, then it can be proven that O(N³) extra data copy will be done by a DGEMM that does data copy. A way to fix this problem is to choose a data format for A that DGEMM is going to use, thereby removing the data copying part of DGEMM. Since the domain of operation in A whose size is N by N, the one time data copying will be O(N²).

A general proof of the last statement would require looking at all the DLAFA of LAPACK. The inventors have examined the so-called “big three” DLAFA, namely LU=PA (Gaussian elimination with partial pivoting), Cholesky factorization (factorization of a positive definite symmetric matrix), and QR=A (Householder factorization of a general matrix).

In each of these LAPACK algorithms, DGEMM is called n1=[N/NB] (also known as the “ceil (N/NB)”) times. The inventors have shown that the total area of the DGEMM operands over all these n1 calls is O(N³).

On the other hand, if one uses the data structures described herein, the following is true for these three algorithms: there is a one-time transformation cost of A from standard column or row major format of FORTRAN or C to the data structures of the present invention.

Clearly, this cost is O(MN), as input matrix is either M by N or N by N. Additionally, the inventors have shown that the rearrangement costs of their data structures during the entire factorization is O(MN) or O(N²).

DGEMM implementations usually include a blocking routine that calls a kernel routine (e.g., DATB, described above) multiple times on submatrices (blocks) of its input operands A, B, C. These submatrices are usually chosen to have a different data format (e.g., data copying is done).

Therefore, the inventors have recognized that a way to fix the problem posed above is to expose the internal data format of DGEMM and thereby provide a kernel interface for DGEMM. In other words, provide the ability to call through to the kernel and bypass the data re-formatting.

First, it is noted that the kernel routines operate on data in the L1 cache. Since each piece of data is used multiple times, the mapping process is justified. This mapping can be accomplished by making the cache resident operands contiguous.

However, this is not enough, since now the FPU register file-to-L1 interface must also be carefully examined. One ideally wants data to also pass though this interface in an optimal way. For modern architectures this means stride-one access so that, for example, dual (quad) or multiple loads can be utilized in concert with multiple FPU operations.

Additionally, stride-one FPU register loading is required for utilizing dual or multiple FPU operations, if such exist. The list of processors with (short) vector instructions for FPU operations is growing quite rapidly and these machines will operate most efficiently (e.g., up to its architectural potential) if there are corresponding (short) vector loads and stores.

The kernel routine will now be examined in more detail. It will be assumed that a register block of C resides in the FPU register file of size mb by nb. So, mb*nb independent dot products, each of size k, are being performed by the FPU. This means mb rows of A and nb cols of B are required to feed these mb*nb dot products (e.g., reference the T's shown in FIG. 6). For each L, 0≦L<k, a column vector of length mb is needed from A and a row vector of length nb from B.

However, since A is stored by rows and B by columns, it appears the mb column of A and the nb rows of B must be loaded with strides lda and ldb. It is noted that lda=ldb=nb for the choice of contiguous data formats.

In the earlier, above-referenced co-pending patent application, a register blocking was introduced for input matrices A, B and C. This led to the concept of the pseudo matrix for both A and B. However, each mb by k submatrix of A and each k by nb submatrix of B are just concatenations of k/kb register blocks of A and k/kb register blocks of B.

In other words, A is a concatenation of m/mb matrices of size mb by k stored by col (lda=mb) and B is a concatenation of n/nb matrices of size k by nb (ldb=nb).

Actually, in Fortran, each n/nb submatrix is an F=B′, recalling the implicit duality in the representation B(F) stated above. So, A and B can be viewed as a concatenation of standard two dimensional arrays.

But a concatenation of two dimensional arrays is also a standard three dimensional array of Fortran or C. This means that a standard compiler technology can be used and the DGEMM routines can be written entirely in a high level language. This is a departure from past practice of coding these routines in assembly language in order to take advantage of such insights.

An L1 DGEMM kernel must initially bring its operands, A, B and C, in from memory or some cache Li, where i≧1. Modern architectures feature both hardware (HW) and/or software (SW) streaming. Again, (almost always) streaming only works for stride-one (on current processors).

It was discussed above how mb rows of A and nb columns of B are needed to feed a register block of C. Using standard arrays in Fortran, this requires mb+2*nb or 2*mb+nb streams of A, B and C.

However, the above paragraph demonstrates that two streams suffice for A and B. And by concatenating register blocks of C (a four-dimensional standard Fortran array) together, one gets a single stream for C. This number (=3) of streams for A, B and C is clearly minimal. It is noted that there is a way in which one could interleave the matrices in order to reduce the stream count to 1, but it involves using O(n³) space and this is impractical in any realistic setting.

What has been described in detail is the case C=C−AB. The same is true for D=D−FE because the transpose identities hold as described above. These arrays are prepared for a DGEMM invocation of multiple calls to a single DGEMM kernel. The preparation is predicated on use of both HW and SW prefetching (e.g., “streaming”). Furthermore, this streaming also works at the L1/FPU register file interface.

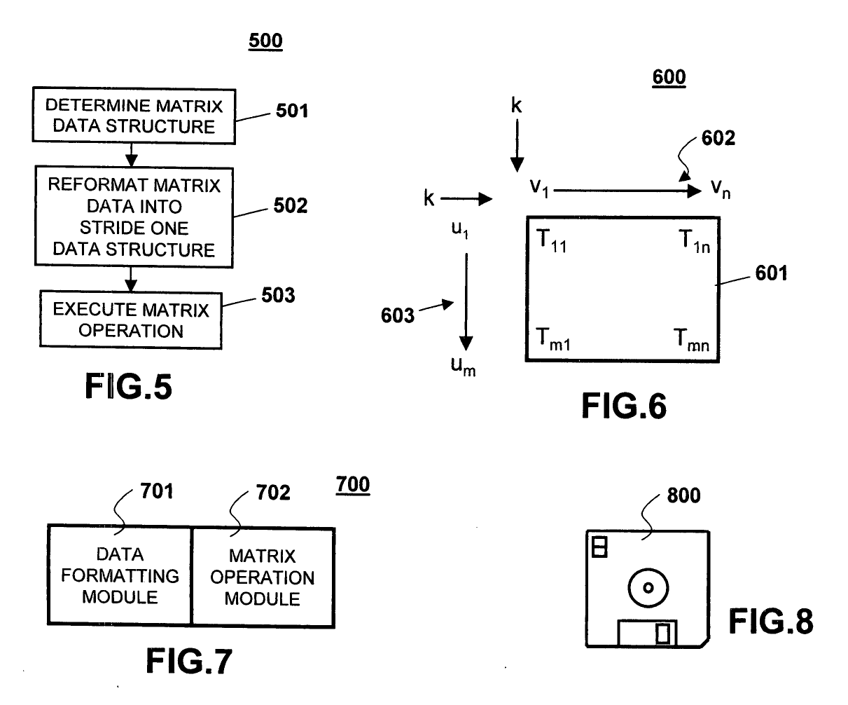

FIG. 5 illustrates in flowchart format 500 an exemplary embodiment of the present invention. In step 501, it is determined which matrix data structures are most efficient for the linear algebra kernel subroutine for data to be retrieved in stride one format for each matrix. In the DGEMM example discussed above, the most efficient data structure for the blocks of data from each of the three matrices requires that the respective current matrix sub-blocks of data be formatted in stride one format. Once this most efficient format is achieved, the data block remains in L1 cache throughout the duration of the kernel processing for those sub-blocks.

The significance of this step is the recognition that current compilers are not aware that matrix data must be constantly reformatted when retrieved from conventional memory storage in which only columns of matrix data or only rows of matrix data is accessible. Optimally, if the data requirements of the kernel can be determined, this reformatting is eliminated.

Although this step 501 can be achieved by a programmer who determines, by evaluating the kernel, the most efficient data structure, there is no reason that this step 501 cannot be executed automatically by a software module that execute steps to determine whether the kernel requires row data or column data for each matrix involved in the kernel.

As discussed above, a part of this determination is also a determination of which format the linear algebra subroutine will be written or executed. That is, this step 501 includes the determination whether the matrix operation will be expressed in terms of matrices in a normal format or a transposed format.

In step 502, each matrix data sub-block is reformatted as appropriate so that the sub-block data is reformatted only once for the kernel, as this data is readied for processing by the linear algebra subroutine. It should be noted that the reformatting of this step could also be done at the matrix macro level, so that the entire matrix is reformatted once, rather than reformatting at the sub-block level as the sub-block is retrieved for processing by the FPU.

In step 503, the linear algebra subroutine processes the matrix data in the FPUs. As mentioned earlier, the present invention provides the advantage that the linear algebra subroutines can now be efficiently written in high level languages, rather than being confined to a lower level language as in the conventional methods, since the data structure of the present invention overcomes the deficiency of high level languages in which the whole matrix data is accessible only in one of rows or columns.

Key algorithms of linear algebra are the DLAFA algorithms. These DLAFA require O(N³) operations on O(N²) data. The present invention specifically addresses algorithms that do a large constant amount of operations per data item. The reason is that data reformatting is not free and requires a minimum of O(N²) operations.

A large amount of data reformatting operations clearly happens for O(N³) algorithms operating on O(N²) data, when the Level-3 BLAS routines are invoked O(N) times. However, the present invention reduces the amount of data reformatting in these algorithms down to O(N²) operations.

The O(N²) dense linear algebra algorithms that use standard Fortran/C data structure are not amenable to the concepts of the present invention.

FIG. 6 illustrates the concept 600 of vector formatting in stride one that might be used in an exemplary embodiment of the present invention in, for example, the DGEMM matrix operation illustrated in FIG. 1. FIG. 6 shows the fundamental GEMM building block in vector form. Sub-block 601 represents a subset of matrix C, vector 602 represents a sub-block of matrix B, and vector 603 represents a sub-block of matrix A. In conventional methods, this matrix data is viewed as lines of matrix data expressed as lines of either rows or columns. In contrast, in the present invention, this data is considered as being register-blocks of sub-matrix data as reformatted in stride one format for efficiency of calculation by the FPU that is also utilizing hardware streaming.

One factor to be considered in the data structure chosen for each submatrix is whether the operation is to be executed as expressed in normal format or in transpose format. For example, in one exemplary embodiment, the transposed version of DGEMM permits that data streaming involves only three streams, instead of the mb streams required for the normal expression. That is, in the transposed expression, matrix A is stored in columns and matrix B is stored in rows, exactly the opposite shown in FIG. 1, in which the DGEMM operation is shown as executed in normal matrix format.

FIG. 7 illustrates in block diagram format 700 an exemplary embodiment of the present invention in which data formatter module 701 reorganizes one or more matrix data structures prior to execution by the matrix operation module 702. Either module 701, 702 of the present invention could be written in a high level language, such as C or Fortran.

In addition to the hardware/software environment described above, a different exemplary aspect of the invention includes a computer-implemented method for performing the invention.

Such a method may be implemented, for example, by operating a computer, as embodied by a digital data processing apparatus, to execute a sequence of machine-readable instructions. These instructions may reside in various types of signal-bearing media.

Thus, this exemplary aspect of the present invention is directed to a programmed product, comprising signal-bearing media tangibly embodying a program of machine-readable instructions executable by a digital data processor incorporating the CPU 211 and hardware above, to perform the method of the invention.

This signal-bearing media may include, for example, a RAM contained within the CPU 211, as represented by the fast-access storage for example. Alternatively, the instructions may be contained in another signal-bearing media, such as a magnetic data storage diskette 800 (FIG. 8), directly or indirectly accessible by the CPU 211.

Whether contained in the diskette 800, the computer/CPU 211, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless.

The second exemplary aspect of the present invention can be embodied in a number of variations, as will be obvious once the present invention is understood. That is, the methods of the present invention could be embodied as a computerized tool stored on diskette 800 that contains a series of matrix subroutines to solve scientific and engineering problems using matrix processing in accordance with the present invention. Alternatively, diskette 800 could contain a series of subroutines that allow an existing tool stored elsewhere (e.g., on a CD-ROM) to be modified to incorporate one or more of the principles of the present invention.

The second exemplary aspect of the present invention additionally raises the issue of general implementation of the present invention in a variety of ways.

For example, it should be apparent, after having read the discussion above that the present invention could be implemented by custom designing a computer in accordance with the principles of the present invention. For example, an operating system could be implemented in which linear algebra processing is executed using the principles of the present invention.

In a variation, the present invention could be implemented by modifying standard matrix processing modules, such as described by LAPACK, so as to be based on the principles of the present invention. Along these lines, each manufacturer could customize their BLAS subroutines in accordance with these principles.

It should also be recognized that other variations are possible, such as versions in which a higher level software module interfaces with existing linear algebra processing modules, such as a BLAS or other LAPACK or ScaLAPACK module, to incorporate the principles of the present invention.

Moreover, the principles and methods of the present invention could be embodied as a computerized tool stored on a memory device, such as independent diskette 800, that contains a series of matrix subroutines to solve scientific and engineering problems using matrix processing, as modified by the technique described above. The modified matrix subroutines could be stored in memory as part of a math library, as is well known in the art. Alternatively, the computerized tool might contain a higher level software module to interact with existing linear algebra processing modules.

It should also be obvious to one of skill in the art that the instructions for the technique described herein can be downloaded through a network interface from a remote storage facility.

All of these various embodiments are intended as included in the present invention, since the present invention should be appropriately viewed as a method to enhance the computation of matrix subroutines, as based upon recognizing how linear algebra processing can be more efficient by using the principles of the present invention.

In yet another exemplary aspect of the present invention, it should also be apparent to one of skill in the art that the principles of the present invention can be used in yet another environment in which parties indirectly take advantage of the present invention.

For example, it is understood that an end user desiring a solution of a scientific or engineering problem may undertake to directly use a computerized linear algebra processing method that incorporates the method of the present invention. Alternatively, the end user might desire that a second party provide the end user the desired solution to the problem by providing the results of a computerized linear algebra processing method that incorporates the method of the present invention. These results might be provided to the end user by a network transmission or even a hard copy printout of the results.

The present invention is intended to cover all of these various methods of implementing and of using the present invention, including that of the end user who indirectly utilizes the present invention by receiving the results of matrix processing done in accordance with the principles herein.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

1. A method of executing an algorithm on a computer, said method comprising:
for a matrix algorithm requiring an order of N³ operations including data reformatting operations, where N is a dimension of an operand of said algorithm, initially reformatting data for at least one matrix used in said algorithm into a data structure stored in a memory, such that stride one data is presented for all sub matrices used as operands involved in said algorithm in a format required by said algorithm substantially with no further data re-formatting beyond an order N² data re-formatting required for executing said algorithm.

2. The method of claim 1, wherein said algorithm has its operands expressed in a transposed format.

3. The method of claim 1, wherein, for said data structure, no more than three data streams are presented into said algorithm.

4. The method of claim 1, wherein said data reformatting occurs in units of submatrix data to be consumed in said algorithm as executed in floating point units (FPUs).

5. The method of claim 1, further comprising:
executing said algorithm in a processing unit.

6. The method of claim 5, wherein said processing unit comprises at least one floating point unit (FPU).

7. The method of claim 5, wherein a coding of at least one of said data reformatting and said algorithm executing comprises code written in a high level language, said high level language code being compiled into a source code for executing said algorithm on data stored in memory.

8. The method of claim 6, wherein said stride one data for all submatrices involved in said algorithm is stored in a level 1 cache associated with said at least one FPU.

9. An apparatus, comprising:
a data formatting module to place matrix data into a data structure prior to processing said data in a linear algebra algorithm requiring an order of N³ operations including data reformatting operations, where N is a dimension of input operands of said algorithm, said data structure providing a data format for said processing that requires substantially no additional data re-formatting beyond an order N² data re-formatting required for executing said algorithm.

10. The apparatus of claim 9, further comprising:
a memory to store said data in said data structure.

11. The apparatus of claim 9, further comprising:
a processing unit to execute said processing.

12. The apparatus of claim 10, wherein said memory comprises a cache memory.

13. The apparatus of claim 1 1, wherein said processing unit comprises:
at least one floating point unit (FPU); and
a matrix algorithm module to execute instructions for said processing.

14. The apparatus of claim 13, wherein said matrix algorithm module comprises source code resultant from a compilation of code written in a higher level language.

15. The apparatus of claim 10, wherein said data structure stores said data in a stride one format.

16. A signal-bearing medium tangibly embodying a program of machine-readable instructions executable by a digital processing apparatus to perform a linear algebra algorithm requiring an order of N³ operations, including data reformatting operations, where N is a dimension of an operand of said algorithm, said instructions comprising:
a data formatting module to place matrix data into a data structure prior to processing said data in said linear algebra algorithm, said data structure providing a data format for said processing that requires substantially no additional data re-formatting beyond an order N² data re-formatting required for executing said algorithm, where N is a dimension of said operands.

17. The signal-bearing medium of claim 16, said instructions further comprising:
a matrix algorithm module to execute instructions for said processing.

18. The signal-bearing medium of claim 17, wherein at least one of said data formatting module and said matrix algorithm module is stored as code written in a high level language.

19. The signal-bearing medium of claim 16, as stored in a memory accessible to a computer network, wherein said signal-bearing medium is loaded onto a server to be transmitted to a user on said network.

20. A system comprising:
means for reformatting data for at least one matrix used in a matrix algorithm requiring an order of N³ operations, including data reformatting operations, where N is a dimension of an input operand of said algorithm, into a data structure stored in a memory, such that stride one data is presented for all sub matrices used as operands involved in said matrix algorithm in a format required by said matrix algorithm substantially with no further data re-formatting beyond an order N² data re-formatting required for executing said algorithm, where N is a dimension of said input operands; and
means for executing said matrix algorithm.

21. A computer, comprising:
means for reformatting data for at least one matrix used in a matrix algorithm requiring an order of N³ operations, including data reformatting operations, where N is a dimension of an input operand of said algorithm, into a data structure stored in a memory, such that stride one data is presented for all submatrices used as operands involved in said matrix algorithm in a format required by said matrix algorithm substantially without further data re-formatting beyond an order N² data re-formatting required for executing said algorithm, where N is a dimension of said input operands; and
means for executing said matrix algorithm.
